(19) United States
(12) Patent Application Publication
(10) Pub. No.: US 2005/0228799 A1
(43) Pub. Date: Oct. 13, 2005

(54) Providing program and policy information to managers

(76) Inventors: Timothy S. Farlow, Needham, MA (US); James Fernandes, Plymouth, MA (US); Shelley Moore, Holliston, MA (US)

Correspondence Address: FISH & RICHARDSON PC, P.O. BOX 1022, MINNEAPOLIS, MN, 55440-1022, US

(21) Appl. No.: 10/815,021

(22) Filed: Mar. 30, 2004

(51) Int. Cl. G06F 17/00

(52) U.S. Cl. 707/100

(57) ABSTRACT

Information is stored about policies or programs of an enterprise that are to be implemented by a manager of the enterprise, the policies or programs being associated with events in the operation of the enterprise. A portion of the information—that has been selected based on a current context in which the manager is working—is delivered for display to the manager on a user interface. A user is enabled to author content about the policies or programs. The authored content is stored in a manner that enables delivery of the content for display to a manager on a user interface. A choice of which content will be delivered is based on a current context in which the manager is working. Information is accumulated about usage by a manager of an enterprise of information about the policies or programs, and the usage information is made available to a compliance employee of the enterprise for analysis. The content includes original nouns or other words or phrases or descriptions that are used repeatedly and consistently, for example, to describe classes of people associated with the enterprise. The user is enabled to define substitute nouns to replace automatically all of the original nouns in all of the content for different events that is distributed to the manager through a user interface. The manager is enabled to confirm electronically that he has read the displayed information. The electronic confirmation is delivered to the compliance employee.

### BACKGROUND

This description relates to providing program and policy information to managers.

Managers in enterprises are charged with understanding policies and programs of the enterprises that apply both to their work and to their other responsibilities as managers. Straightforward policies and programs that continually apply to their principal job function (for example, documentation standards to be applied by software developers to their code) are typically well-known by the managers. Other policies and programs, by contrast, may be complex and/or less frequently applied and therefore less well understood by the managers who must implement them. Enterprises typically provide a variety of ways for a manager to learn and use such policies and programs effectively, for example, seminars and manuals.

### SUMMARY

In general, in one aspect, the invention features a method that includes (a) storing information about policies or programs of an enterprise that are to be implemented by a manager of the enterprise, the policies or programs being associated with events in the operation of the enterprise, and (b) delivering for display to the manager on a user interface, a portion of the information that has been selected based on a current context in which the manager is working.

Implementations of the invention may include one or more of the following features. The policies or programs are associated with human resources events. The current context includes occurrence of one of the events. The event includes a human resources event associated with an employee who reports to the manager. In some cases, the event may be associated directly with the manager, without an association of any other employee. The current context includes information associated with the manager. The information associated with the manager includes at least one of: the manager's responsibilities, the manager's experience, the manager's demographic characteristics, and characteristics of the employees that report to the manager. The portion of the information delivered to the manager includes serving the information through a web browser. The manager is enabled to control interactively which portion of the information is delivered. The information that is delivered includes general information and policy statements and the method also includes identifying the policy statements in a visually distinct way in the user interface. The portion of the information is associated with an action to be taken by the manager. The information includes descriptions of milestones associated with the action. The information includes descriptions of tasks that are part of the action. The portion of the information includes information about employees who report to the manager. The manager is enabled to confirm that he has taken a required step with respect to the portion of the information. The step includes reading the portion.

In general, in another aspect, the invention features a method that includes (a) enabling a user to author content about policies or programs of an enterprise that are to be implemented by a manager of the enterprise, the content being associated with events in the operation of the enterprise, (b) storing the authored content in a manner that enables delivery of the content for display to a manager on a user interface, and (c) enabling a choice of which content will be delivered based on a current context in which the manager is working.

Implementations of the invention may include one or more of the following features. The authored content is stored in a manner that enables the delivery of content for a given event independently of content for other events. The user is enabled to author content for an event in a word-processing type interface that has a visual appearance similar to one that is displayed to the manager. The author is enabled to organize the authored content by event.

In general, in another aspect, the invention features a method that includes accumulating information about usage by a manager within an enterprise of information about policies or programs of an enterprise that are to be implemented by the manager, the policies or programs being associated with events in the operation of the enterprise, and making the usage information available to a compliance employee of the enterprise for analysis

Implementations of the invention may include one or more of the following features. The usage information is made available as a compliance report displayed by a browser to the compliance employee. The usage information is made available as a usage report. The policies or programs information is organized by events in the operation of the enterprise, and the usage information includes a usage report that shows usage by managers according to the events. The events include human resources events. The usage information is indicative of whether the manager has read the policies or programs information. Usage information may also relate to general use by the manager of the system, which enables administrators and analysts to view which programs and policies have been used most and then to refine the system and the programs and policies.

In general, in another aspect, the invention features a method that includes (a) enabling a user to author content about policies or programs of an enterprise that are to be implemented by a manager of the enterprise, the content being associated with events in the operation of the enterprise, the content for different events being authored and stored independently, the content including original nouns (or other words or phrases or descriptions) that are used repeatedly and consistently (for example, to describe classes of people associated with the enterprise), and (b) enabling the user to define substitute nouns (or words or phrases or descriptions) to replace automatically all of the original nouns (or words or phrases or descriptions) in all of the content for different events that is distributed to the manager through a user interface. This enables the information to be changed and maintained easily by the user.

In general, in another aspect, the invention features a method that includes displaying to a manager of an enterprise, information about policies or programs of an enterprise that are to be implemented by the manager of the enterprise, enabling the manager to confirm electronically that he has read the displayed information, and delivering the electronic confirmation to a compliance employee of the enterprise for analysis.

In general, in another aspect, the invention features a method that includes enabling a user to author an event and to have corresponding display pages automatically created and published.

Other aspects of the invention encompass media bearing instructions to cause a machine to perform certain actions, apparatus for performing various methods, and other combinations of the aspects and features recited above.

Other advantages and features will become apparent from the following description and from the claims.

### DESCRIPTION

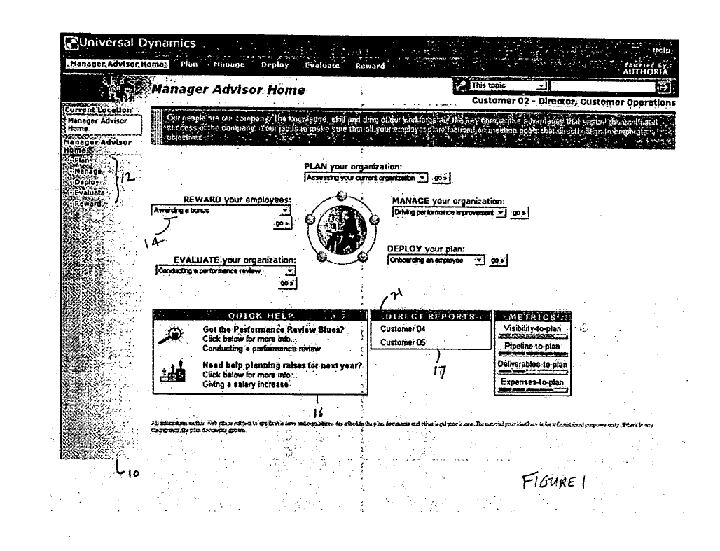

FIGS. 1 through 11 are screen shots.

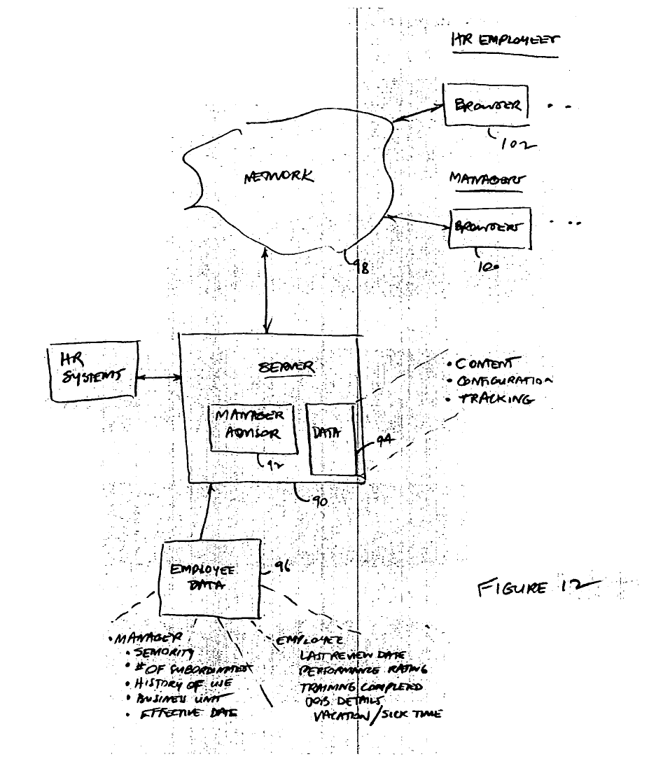

FIG. 12 is a block diagram.

By storing appropriate information about an enterprise's policies and programs and by understanding the context in which the information is needed at a given time (for example, the location and role of the manager), it is possible to provide useful and appropriate portions of the information to a manager at a single access point efficiently, rapidly, accurately, at the right moment, and in the right place. This improves the productivity of the manager, saves time, and may reduce potential liabilities, risks, and costs.

Information presented to the manager may also relate to training programs available to the manager. The information may alert him to the existence of changes to the training and may reinforce completed training by presenting additional content later.

By observing the use of the available information by managers, usage trends may be analyzed. Compliance with training and with policies and procedures by managers can be monitored automatically.

The kinds of information that may be stored and presented may, for example, relate to staffing management (planning, recruiting, and administration), performance management (alignment, measurement, and remediation), compensation management (modeling and administration), development (competencies, training, and succession), and resources (corporate policies and EPR/HRMS).

In a system for developing and presenting human resources information, two views can be provided: one directed to human resources (HR) employees, and the other directed to the managers. The manager view enables the manager to obtain timely and context-sensitive information. The HR view enables HR employees to create and manage the information content and to view and analyze data about usage by managers. Both views may be presented in browser windows on the desktops of the users. The corresponding servers may be centrally located and may be operated specifically by or on behalf of the enterprise. Or they could be operated by a central service on behalf of more than one enterprise. Although the examples are based on a web browser-server model of communication, other modes of communication would also be possible.

Although the examples discussed here are directed to HR information, the techniques are applicable to a wide range of information about policies and programs that may be needed by or useful to a manager. A wide variety of features and functions may be provided in such a program and policy information system.

With respect to the manager's needs, the system may, as indicated, provide situational, just-in-time content designed specifically for managers. The manager may be enabled to find needed information quickly on-line, for example, in three clicks or fewer.

The system can rapidly identify manager issues that should be escalated directly to HR. Pre-built events may be included in areas critical to manager success (for example, how to deal with a subordinate's sexual harassment complaint). A built-in informational architecture provides easy topical information in the areas of planning, deployment, evaluation, development, and rewards. There may also be pre-identified integration points that enable easy connection to other applications used by managers (e.g., compensation, performance management, recruiting).

The manager's user interface is organized as a manager desktop that serves as a single source for all of a manager's HR management tasks. Each manager receives personalized, dynamic content based on his role, group, or department. The context could also include the seniority of the manager, the number of employees he manages, and his history of use of the system for similar questions or unrelated questions. The server stores such context information about each manager who is authorized to access the system. When the manager launches the manager's browser window, the server is able to deliver content based on the context associated with that manager. Thus, the content is varied by role, business unit, effective date, type of employees managed, and other context factors. In addition, the manager can identify specific employees with respect to whom he has a question or issue and in that way access employee information and view employee-specific data, policies, and processes. Searching can be done based on words meaningful to managers. The search results can be manipulated easily. Synonyms may be used to improve search results.

Access to key data is provided with respect to people who directly report to the manger. For example, the manager can view lists of employees and their attributes such as last review date, performance rating, training completed, and more. The look and feel can be easily customized to match existing portals and color schemes.

With respect to the HR view, the system offers one place to manage all manager communication, included the determination of what to say and which audience should receive it. Information to be presented in the system can be created and managed in a single location and replicated throughout the enterprise. The system integrates with and leverages backend data sources and other HR systems.

An authoring desktop enables the HR employee to configure, maintain, and create new content easily. The interface may be as easy and functional as a word processor. Document management capabilities may be included. Multi-user authoring is permitted. Links (URLs) can be managed. Content effective dating is enabled as is versioning.

The system enables the designation of flexible substitution variables for terms that are often used in manager communications, which assures easy and rapid content updates across hundreds of topics. For example, terms like “employees” can be changed to “associates” globally across hundreds of pages of HR content with a single step.

A reporting capability enables tracking whether a manager has read and acknowledged a policy or event. Utilization reporting identifies which topics managers are accessing most frequently and which topics generate the most questions.

The system can be integrated with other applications available on the manager's desktop, without duplicate login. This permits leveraging connections with ERP systems (e.g., PeopleSoft, SAP, Oracle), portals and other benefits and policy products. The system may be integrated with existing security infrastructures for single sign-on capabilities.

As shown in FIG. 1, the home screen 10 in one example of the manager adviser view of the system offers five activities 12: plan, manage, deploy, evaluate, and reward.

Each activity has a number of associated tasks 14 that the manager can perform. He selects a task using the dropdown boxes under the activities shown in the middle of the screen. (In other examples, a wide variety of other actions could be enabled for the manager.)

The screen also shows the user several context or status panes that include quick help opportunities 16 and a list 17 of people who are report directly to this manager.

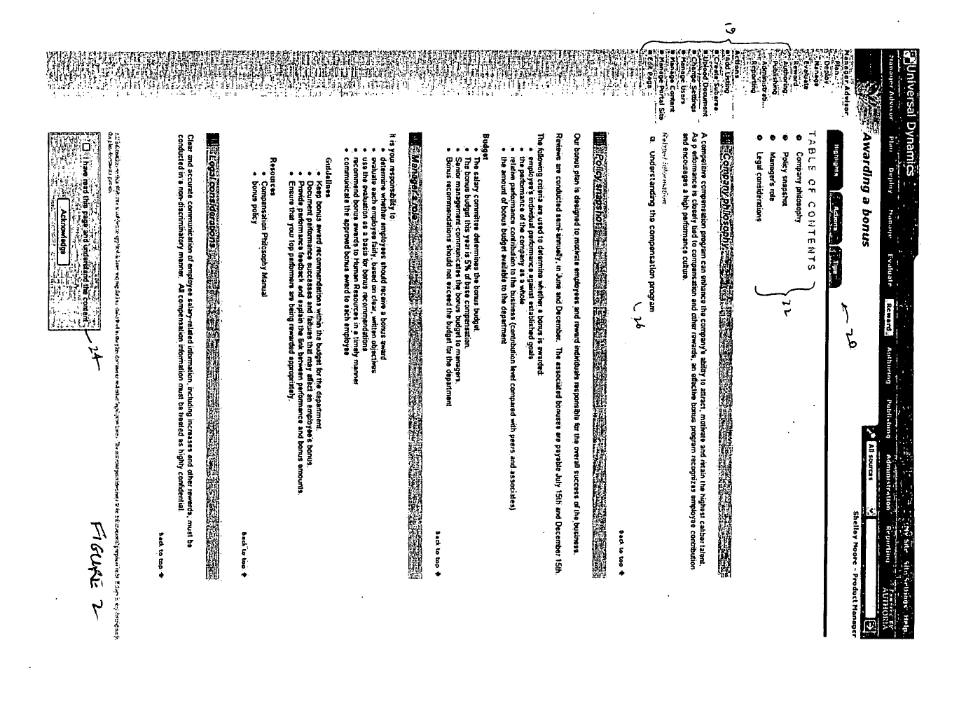

If the manager were to select the activity called “reward your employees” and the task called “awarding a bonus”, he would be presented a screen similar to the one shown in FIG. 2. The specific screen shown in FIG. 2 would be available only to the HR employees who maintain the system because it includes actions 19 that are not meant to be available to the manager. In other respects, the figure illustrates what would be presented to the manager.

With respect to the manager's work, the screen provides information about the activity of awarding a bonus. The enterprise that is related to the screen shown in FIG. 2 permits its managers to grant bonuses to people who report directly to them. The enterprise has policies and programs that govern how managers should award the bonuses. The screen shown in FIG. 2 provides three tabs 20 of information about the policies and programs: highlights (which are shown in the figure), actions, and tips. Highlights summarize the key points that the manager needs to know about the policies and programs. Actions enables the manager to perform actions associated with the current topic. Tips provides useful things for the manager to know about awarding bonuses.

A table of contents 22 at the top of the page lists links to sections that appear later in the page. At the bottom of the page, a confirmation box 24 provides a place for the manager to indicate that he has read and understood the content of the page. When the manager checks the box and clicks “acknowledge”, the information is returned to the server and stored for use by the HR employees in analyzing the use of the system and the performance of the manager. Other kinds of compliance feedback could be requested from the manager, for example, whether he needs additional information about a topic, whether he considers the information provided to be useful, whether he has a question about the material, and whether he read the page (putting aside whether he understood it).

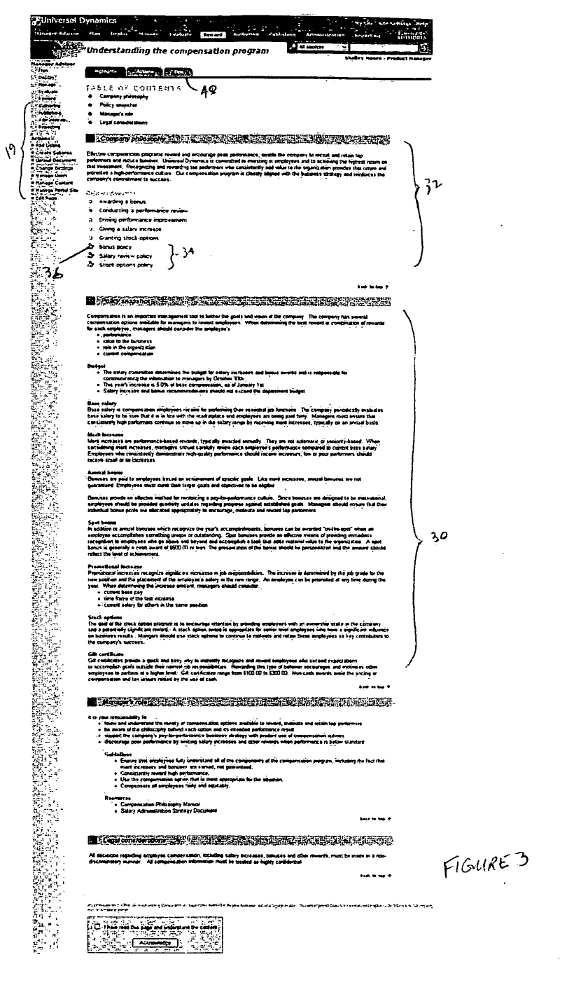

Each of the topics on the page may include a link 26 to additional information. If the manager were to invoke the link for “understanding the compensation program”, he would be presented with the page shown in FIG. 3, which is like FIG. 2 but includes an expanded “policy snapshot” section 30 and an expanded company philosophy section 32.

The company philosophy section includes links 34 to additional information. Links that are directed to specific statements of company policy (as contrasted with instructional material or more general statements) are labeled as policies and are associated with an icon 36 that implies they are policies.

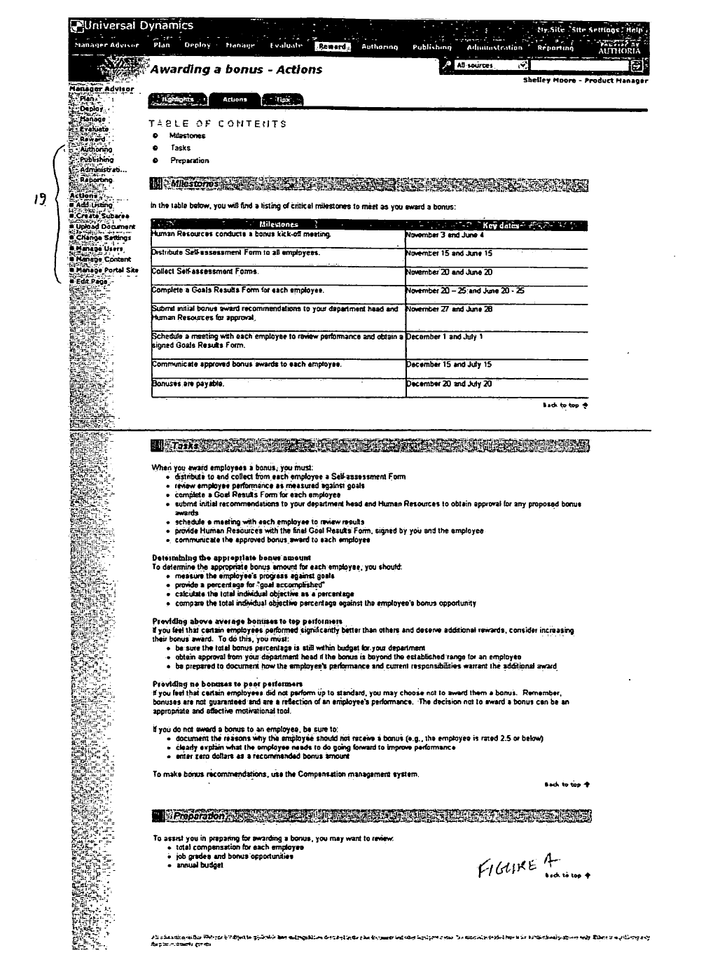

If the manager invokes the actions tab 40, he is presented with a screen like the one shown in FIG. 4 (the specific screen of FIG. 4, as before, is intended for the HR employees and includes additional actions 19). As shown, the actions tab in this example provides three topics: milestones, tasks, and preparation.

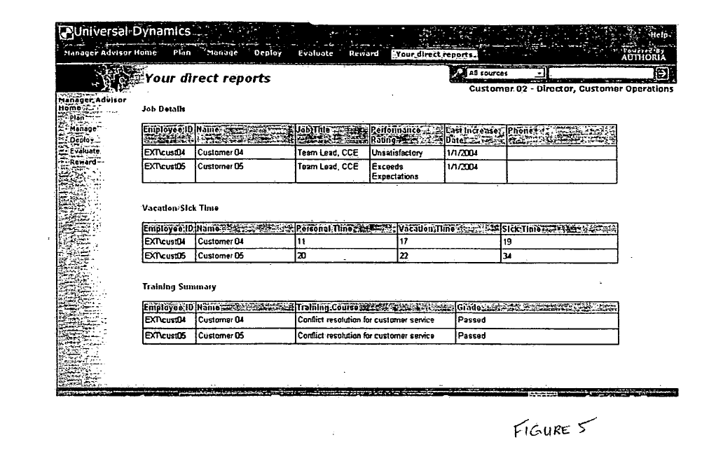

Referring again to FIG. 1, if the manager invokes the heading “direct reports” 21, he is presented the screen shown in FIG. 5. There, specific information about the employees who directly report to the manager is shown. This information may include job details, vacation/sick time, a training summary or other information chosen at the HR user's discretion and designated as part of an implementation.

The specific information that is presented to the manager will depend on the current context in which he is working. For example, if the manager is inexperienced, as indicated in the employee database for the enterprise, he can be presented with more detailed information about a policy, or certain policies can be excluded from his view. The context is determined by the system based on the login information for the user and the stored employee information.

We turn now to the screens that are used by the HR employees to maintain the system.

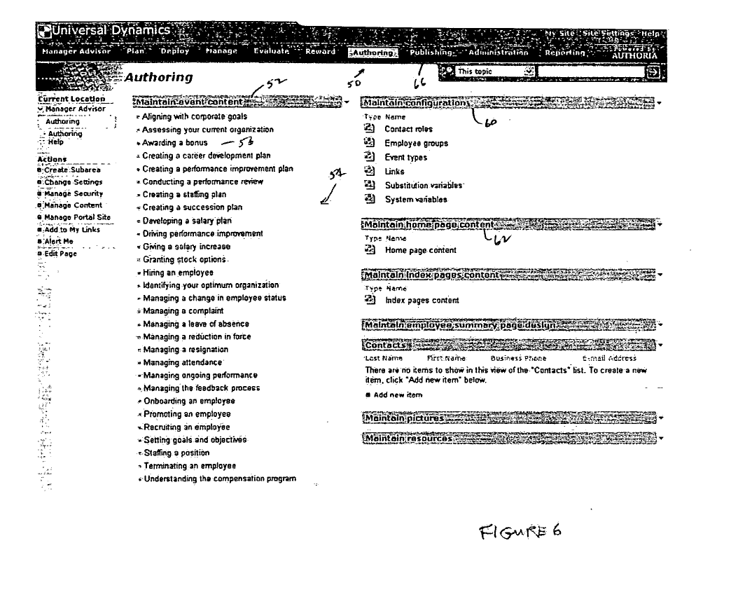

As shown in FIG. 6, the button bar 50 at the top of the screen includes the same six buttons that appear on the manager's view, and also include buttons used to invoke activities involved in managing the system, in this case, authoring, publishing, administration, and reporting. The HR employee can invoke these activities. Different types of HR users may be given permission to invoke different ones of these activities.

FIG. 6 illustrates the screen that is presented when the employee clicks on authoring. The authoring activity enables the employee to maintain the content and configuration of the system as changes are made in the company's policies and programs.

The panes shown in the body of FIG. 6 include maintaining event content 52, which enables the HR employee to maintain the content that is presented to the manager in connection with events that are covered by the system. The list of events 54 includes all of the possible topics that may be available to various managers. However, not all of the topics typically will be available to each manager. Rather, which topics are available to a given manager depends on the context of that manager's position and situation as mentioned before. The HR user may also create additional custom events particular to specific enterprise programs and policies, using a provided template.

To maintain the content of a particular event, the user clicks on the event in list 54. For example, if the user clicks on “awarding a bonus” she is presented the screen shown in FIG. 2. Within the screen, the user may edit, rewrite, or add to the text and links shown. In effect, the user has a simple word processing style of editing page within which to maintain the detailed content that is to be presented to the manager. In addition the editing page has essentially the same appearance as the finished screen that will be presented to the manager. The user also has formatting capabilities to change the appearance of the words displayed to the manager on the user interface.

Referring again to FIG. 6, on the right side of the screen are several panes that enable the user to perform other authoring tasks. Maintaining configuration 60 enables the user to control aspects of the system that do not comprise event content. Maintain home page content 62 enables the user of the system to maintain the content of the manager home page (FIG. 1). Options are also available to maintain index pages content, maintain employee summary page design, contacts, maintain pictures, and maintain resources, as shown.

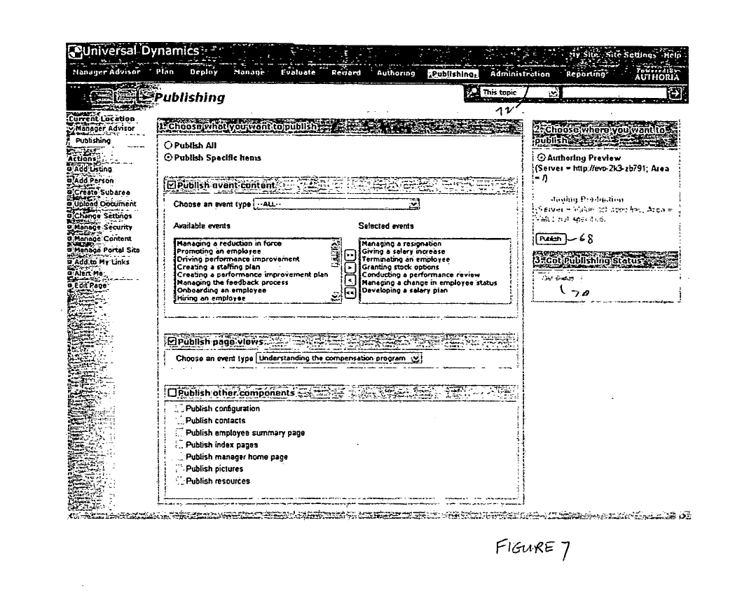

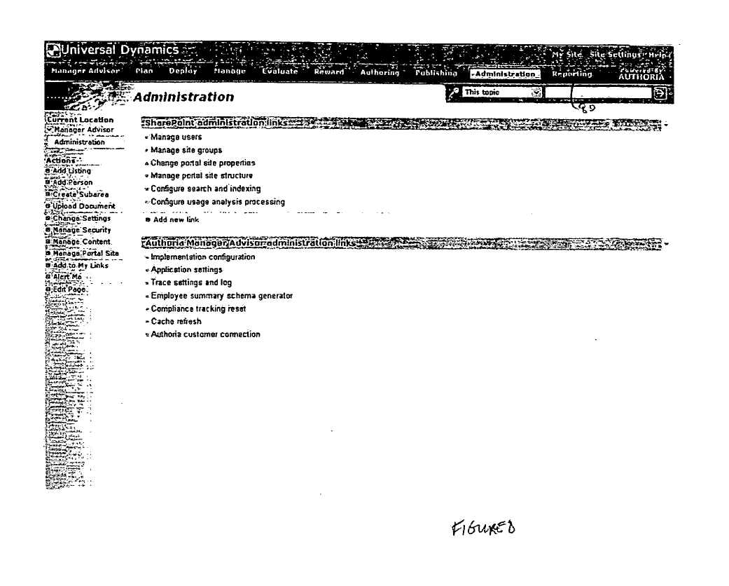

When the “publishing” button 66 is invoked, the system presents the screen shown in FIG. 7. While the user is working in the authoring screen, changes are not published and are not made “live” on the managers' screens. Once the user has completed authoring actions, using the features of FIG. 7, she may publish and make live the changes that have been generated. All items may be published or only selected items. Individual events may be selected for publication. Entire page views may be selected by choosing an event type. And other components may be selected and published. Publication may be made either for authoring preview or for staging production by entering a server address and an area. After the publish button 68 is invoked, the user can get status of the publication by invoking the get status button 70. Clicking on the administration” button takes the user to the screen shown in FIG. 8, where the user can perform administrative functions as listed there. On the first time that the user invokes the publish button with respect to a given event or other aspect of the system, the system creates the web page automatically and then publishes it. On later invocations of the publish feature, the system updates the changed elements of the site and publishes it.

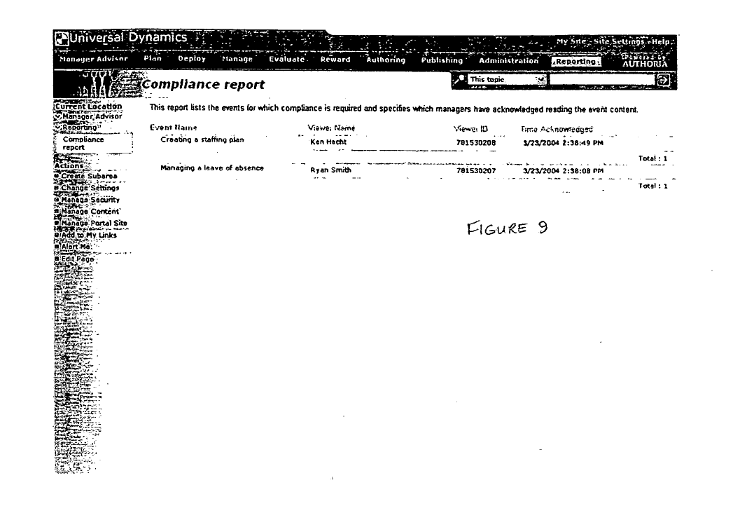

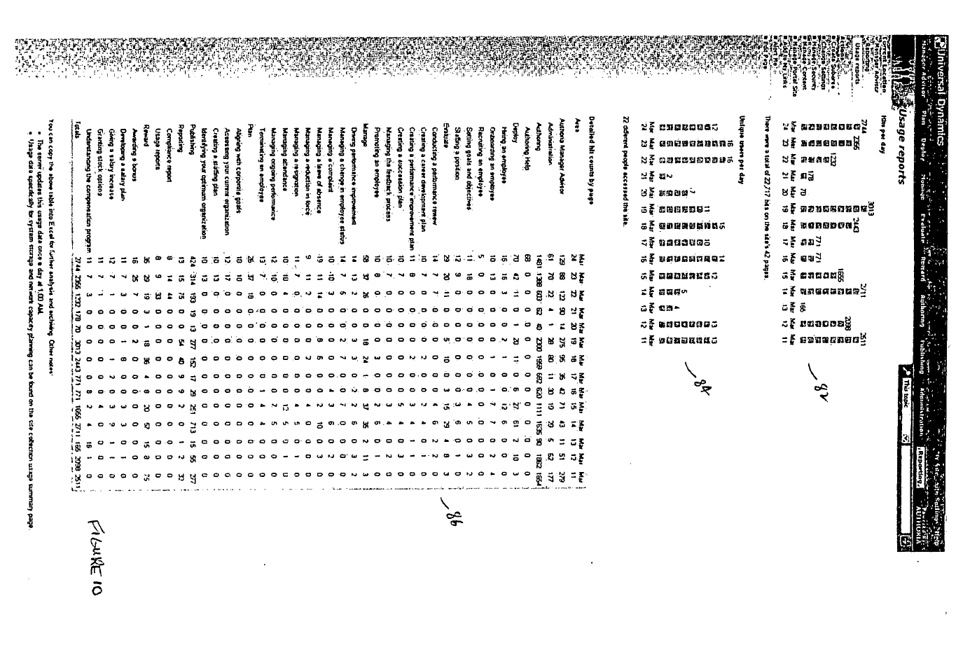

The user may invoke the reporting activity by clicking on the “reporting” button 80, which results in the presentation of the screen shown in FIG. 9. The reporting activity can include different tasks including compliance reporting, as shown in FIG. 9, and usage reports as shown in FIG. 10. As shown in FIG. 9, the compliance report lists events in the system and indicates the compliance status of individual managers with respect to that event. For example, the report shows that Ken Hecht acknowledged having read the event “creating a staff plan” on Mar. 23, 2004.

The usage report shown in FIG. 10 gives statistics about the usage of the manager adviser, including the hits per day 82, the unique users per day 84, and the detailed hit counts by page 86. The latter report is broken down by event and day, giving the HR employee a view of the number of times each of the events was used. This can give a picture of the relative utility and value of different events.

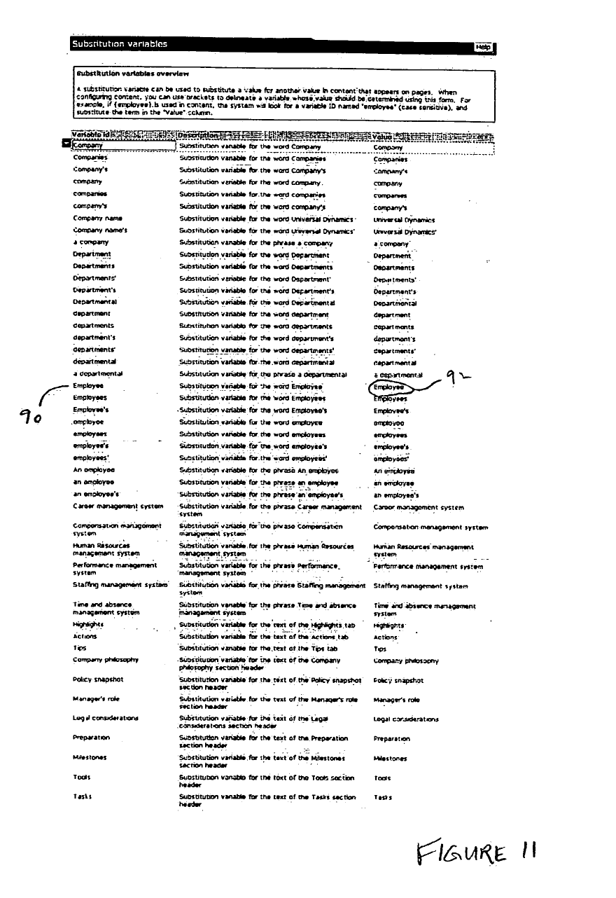

The textual content of the system may repeatedly use nouns or other words or phrases or descriptions (linguistic elements) to describe people, situations, parties, entities, and actions. These linguistic elements tend to be those used in the common lingo of the enterprise. For example, employees known as junior partners may be more or less equivalent to employees known as vice presidents in banks. In addition, the jargon used in an enterprise sometimes changes. Also, the jargon used by one set of employees may be different from the jargon used by another set of employees. In order to be able to substitute one linguistic element for another globally in the content of the system, substitution variables are provided as shown in FIG. 11. For example, the variable id employee 90 may be replaced globally by an entry made by a user in the value column 92 (in the figure, the value is its original value, “employee”; but the word “associate” could be typed to replace “employee” globally). When the content is presented to the user, the substitution is made dynamically. It is also possible to make the linguistic substitution differently for different managers. For example, the content may be presented using the word “sales associate” for one set of managers, but substituted by the phrase “cashier” for a different set of managers.

The system can be implemented in software, hardware, or a combination of software and hardware. As shown in FIG. 12, in one example, the manager advisor software 92 (which may include commercially available components and additional software to coordinate their operation) runs on a server 90 which also contains data 94 needed by the advisor. The data may include content (the text and links of the event pages), configuration information, and tracking information (which tracks usage, and feedback from the users). Employee data 96, provided from an enterprise system, is used by the server to provide employee information to managers and to enable context-sensitive delivery of content to the managers based on their own employee data. The server hosts the manager advisor and interacts through a network 98 with browsers 102 used by HR employees and with browsers 100 used by managers. The network could be the Internet or other wide area network, or an intranet or a local area network.

Other implementations are also within the scope of the claims.

1. A method comprising
storing information about policies or programs of an enterprise that are to be implemented by a manager of the enterprise, the policies or programs being associated with events in the operation of the enterprise, and
delivering for display to the manager on a user interface, a portion of the information that has been selected based on a current context in which the manager is working.

2. The method of claim 1 in which the policies or programs are associated with human resources events.

3. The method of claim 1 in which the current context comprises occurrence of one of the events.

4. The method of claim 3 in which the event comprises a human resources event associated with an employee who reports to the manager,

5. The method of claim 1 in which the current context comprises information associated with the manager.

6. The method of claim 5 in which the information associated with the manager includes at least one of: the manager's responsibilities, the manager's experience, the manager's demographic characteristics, and characteristics of the employees that report to the manager.

7. The method of claim 1 in which delivering the portion of the information to the manager comprises serving the information through a web browser.

8. The method of claim 1 also including
enabling the manager to control interactively which portion of the information is delivered.

9. The method of claim 1 in which the information that is delivered includes general information and policy statements and
the method also includes identifying the policy statements in a visually distinct way in the user interface.

10. The method of claim 1 in which the portion of the information is associated with an action to be taken by the manager.

11. The method of claim 10 in which the information includes descriptions of milestones associated with the action.

12. The method of claim 10 in which the information includes descriptions of tasks that are part of the action.

13. The method of claim 1 in which the portion of the information includes information about employees who report to the manager.

14. The method of claim 1 also including
enabling the manager to confirm that he has taken a required step with respect to the portion of the information.

15. The method of claim 14 in which the step comprises reading the portion.

16. A method comprising
storing information about policies or programs of an enterprise that are associated with human resource events of employees who report to a manager and are to be implemented by the manager,
serving for display to the manager through a web browser, a portion of the information that has been selected based on a current context in which the manager is working,
the current context including at least one of: occurrence of one of the events, the manager's responsibilities, the manager's experience, and characteristics of the employees that report to the manager,
the portion of the information being associated with an action to be taken by the manager, the information including at least one of: descriptions of milestones associated with the action, descriptions of tasks that are part of the action, or information about employees who report to the manager, and
enabling the manager to control interactively which portion of the information is delivered and to indicate that he has read the portion.

17. A medium bearing instructions to cause a machine to
store information about policies or programs of an enterprise that are to be implemented by a manager of the enterprise, the policies or programs being associated with events in the operation of the enterprise, and
deliver for display to the manager on a user interface, a portion of the information that has been selected based on a current context in which the manager is working.

18. Apparatus comprising
storage to hold information about policies or programs of an enterprise that are to be implemented by a manager of the enterprise, the policies or programs being associated with events in the operation of the enterprise, and
a communication medium to deliver for display to the manager on a user interface, a portion of the information that has been selected based on a current context in which the manager is working.

19. A method comprising
enabling a user to author content about policies or programs of an enterprise that are to be implemented by a manager of the enterprise, the content being associated with events in the operation of the enterprise,
storing the authored content in a manner that enables delivery of the content for display to a manager on a user interface, and
enabling a choice of which content will be delivered based on a current context in which the manager is working.

20. The method of claim 19 in which the authored content is stored in a manner that enables the delivery of content for a given event independently of content for other events.

21. The method of claim 19 in which the user is enabled to author content for an event in a word-processing type interface that has a visual appearance similar to one that is displayed to the manager.

22. The method of claim 19 in which the author is enabled to organize the authored content by event.

23. A medium bearing instructions to cause a machine to:
enable a user to author content about policies or programs of an enterprise that are to be implemented by a manager of the enterprise, the content being associated with events in the operation of the enterprise,
store the authored content in a manner that enables delivery of the content for display to a manager on a user interface, and
enable a choice of which content will be delivered based on a current context in which the manager is working.

24. Apparatus comprising
an authoring interface to enable a user (a) to author content about policies or programs of an enterprise that are to be implemented by a manager of the enterprise, the content being associated with events in the operation of the enterprise, (b) to store the authored content in a manner that enables delivery of the content for display to a manager on a user interface, and (c) to enable a choice of which content will be delivered based on a current context in which the manager is working.

25. A method comprising
accumulating information about usage by a manager within an enterprise of information about policies or programs of an enterprise that are to be implemented by the manager, the policies or programs being associated with events in the operation of the enterprise, and
making the usage information available to a compliance employee of the enterprise for analysis.

26. The method of claim 25 in which the usage information is made available as a compliance report displayed by a browser to the compliance employee.

27. The method of claim 25 in which the usage information is made available as a usage report.

28. The method of claim 27 in which the policies or programs information is organized by events in the operation of the enterprise, and the usage information includes a usage report that shows usage by managers according to the events.

29. The method of claim 27 in which the events include human resources events.

30. The method of claim 27 in which the usage information is indicative of whether the manager has read the policies or programs information.

31. A medium bearing instructions to cause a machine to:
accumulate information about usage by a manager of an enterprise of information about policies or programs of an enterprise that are to be implemented by the manager, the policies or programs being associated with events in the operation of the enterprise, and
make the usage information available to a compliance employee of the enterprise for analysis.

32. A method comprising
enabling a user to author content about policies or programs of an enterprise that are to be implemented by a manager of the enterprise, the content being associated with events in the operation of the enterprise, the content for different events being authored and stored independently, the content including original nouns or other words or phrases or descriptions that are used repeatedly and consistently, and
enabling the user to define substitute nouns to replace automatically all of the original nouns or other words or phrases or descriptions in all of the content for different events that is distributed to the manager through a user interface.

33. A method comprising
displaying to a manager of an enterprise, information about policies or programs of an enterprise that are to be implemented by the manager of the enterprise,
enabling the manager to confirm electronically that he has read the displayed information, and
delivering the electronic confirmation to a compliance employee of the enterprise for analysis.
